(19) United States
(12) Patent Application Publication
(10) Pub. No.: US 2019/0367847 A1
(43) Pub. Date: Dec. 5, 2019

(54) Method Of Washing In An Automatic Laundry Machine And Machine Configured For The Method

(71) Applicant: Reckitt Benckiser Vanish B.V., Hoofddorp (NL)

(72) Inventors: Pietro Caputo, Mira (IT); Deney Mong Ming Chu, Mira (IT); Luca Spadoni, Mira (IT)

(21) Appl. No.: 16/484,982

(22) PCT Filed: Feb. 14, 2018
(86) PCT No.: PCT/GB2018/050396

§ 371 Date: Aug. 9, 2019

(30) Foreign Application Priority Data
Feb. 15, 2017 (GB) 1702441.5
Feb. 13, 2018 (GB) 1802311.9

(51) Int. Cl. C11D 11/00; C11D 1/83; C11D 3/395; C11D 3/386; D06F 35/00; D06F 39/04

(52) U.S. Cl. CPC C11D 11/0094; C11D 11/0017; C11D 1/83; C11D 3/3953; D06F 39/04; C11D 3/38618; C11D 3/38636; C11D 3/38627; D06F 35/006; C11D 3/3951

(57) ABSTRACT

A method of washing in an automatic laundry machine having a wash tank, including the following steps: delivering a first composition comprising a bleach composition to the tank in a first step; delivering a second composition comprising at least one surfactant composition to the tank in a second step; delivering a third composition comprising at least one enzyme to the tank in a third step; wherein water is added to the wash tank at the same time or after the first step but prior to the third step; the temperature of the water in the wash tank is elevated before, during or after the first step and/or the second step; and the temperature of the water in the wash tank is subsequently reduced before the third step.

The invention relates to domestic laundry washing, especially by a method which outperforms the current standard cotton wash programs available on most automatic laundry machines.

Automatic laundry washing machines have been present in homes and commercial premises for decades. They offer genuine benefits in terms of speed of cleaning, consistency of cleaning and convenience with respect to manual washing.

Whilst automatic laundry washing machines offer convenience for the user there are concerns over their usage of energy, water and detergents. Consumers want ever increasing efficiency in all of these areas whilst still maintaining excellent laundry washing. The present invention addresses these technical problems.

According to a first aspect of the invention, there is provided a method of washing in an automatic laundry machine having a wash tank, comprising:
(a) in a first step, delivering a first composition comprising a bleach composition to the tank;
(b) in a second step, delivering a second composition comprising at least one surfactant composition to the tank;
(c) in a third step, delivering a third composition comprising at least one enzyme to the tank;
wherein water is added to the wash tank at the same time or after the first step (a) but prior to the third step (c);
characterised in that the temperature of the water in the wash tank is elevated before, during or after the first step (a) and/or the second step (b);
and that the temperature of the water in the wash tank is subsequently reduced before the third step (c).

The first composition may further comprise one or more surfactants.

The at least one enzyme in the third composition may be dispersed in one or more surfactants. The one or more surfactants may be in a solution.

The method may further comprise the step of adding a quantity of the third composition with the first composition in the first step prior to, during or after elevating the temperature of the water in the wash tank. Elevation of the temperature of the water in the tank can be achieved by the known heating means common to most automatic laundry machines. However, as discussed below, the wash water will still be cooled before the third step of delivering the third composition to the tank. The quantity of the third composition added in the first step is preferably in an equal or lesser amount to that added in the third step.

The surfactants used in the first and/or second and/or third step may be the same or different to each other.

The bleach is an oxygen bleach, preferably an inorganic perhydrate, preferably a percarbonate.

The first composition comprises one or more further ingredients selected from the group consisting of: a bleach activator; a bleach catalyst; a builder; and an alkaliser.

The third composition is substantially bleach-free or, most preferably, bleach-free. The third composition may further comprise a builder.

The method may further comprise an optional fourth step of removing water from the wash tank followed by the step of delivering a fourth composition comprising esterquats, to the wash tank.

In an embodiment, the maximum temperature reached during the first step is no more than 70° C., preferably no more than 65° C., preferably no more than 60° C., preferably no more than 55° C., preferably no more than 50° C., preferably no more than 45° C., preferably no more than 40° C., preferably no more than 35° C., preferably no more than 30° C., preferably no more than 25° C., preferably no more than 20° C., preferably no more than 15° C.; and/or the maximum temperature reached during the first and/or second steps is at least 15° C., preferably at least 20° C., preferably at least 25° C., preferably at least 30° C., preferably at least 40° C.

In an embodiment the water in the tank is cooled before the third composition is added to the wash to a maximum temperature of no more than 35° C., preferably no more than 30° C., preferably no more than 25° C., preferably no more than 20° C., preferably no more than 15° C.; and/or the maximum temperature reached during the first and/or second steps is at least 15° C., preferably at least 20° C., preferably at least 25° C., preferably at least 30° C., preferably at least 40° C.

In an embodiment, the length of the first step is no more than 60 minutes, preferably no more than 50 minutes, preferably no more than 40 minutes, preferably no more than 30 minutes, preferably no more than 20 minutes, preferably no more than 10 minutes, preferably no more than 5 minutes and/or the length of the second step is no more than 60 minutes, preferably no more than 50 minutes, preferably no more than 40 minutes, preferably no more than 30 minutes, preferably no more than 20 minutes, preferably no more than 10 minutes, preferably no more than 5 minutes

In an embodiment, the total volume of wash water used in the main wash, i.e. the part of the automatic laundry machine's cycle where the laundry detergents are added, is no more than 20 litres, preferably no more than 15 litres, preferably no more than 5 litres, preferably no more than 3 litres for a standard, full load of 7 kg.

The invention also relates to an automatic laundry washing machine configured to carry out a method as described herein.

The present invention has been found to be surprisingly advantageous.

Overall the wash cycle of the present invention delivers excellent washing performance whilst using less energy when compared to a standard wash.

By dosing the bleach in a first step it has been found that excellent cleaning can be achieved. In particular, there is an improvement in the cleaning performance for bleachable and greasy stains.

Further ancillary benefits are that a smaller amount of water and bleach can be used to achieve equivalent washing performance compared to standard wash programmes. Consequently, although the first and/or second steps are carried out at an elevated temperature, less energy is used as a smaller amount of water is to be heated in the first and/or second step.

Ordinarily when a laundry washing machine cycle employs a step which is performed at an elevated temperature no active cooling is employed once said cycle is finished. Instead, the temperature is simply allowed to fall. In contrast, the method of the present invention specifically incorporates an active cooling step before the third step is carried out. This ‘thermal shock’ step has been found to enable excellent cleaning performance on bleachable and greasy stains within a standard one hour cotton wash cycle and/or a shorter washing time for other programmes.

The reduction in temperature of the water in the wash tank may be achieved by the addition of water which is at a temperature lower than that of the tank. This addition may be carried out separately to or in conjunction with one or more of steps (a) and (b) but always prior to the addition of the third composition containing the at least one enzyme. The cooler water can be fed directly from the household's/commercial premise's cold water supply. Advantageously, the temperature of the water in the wash tank is reduced by at least 3° C., such as at least 4° C., preferably at least 5° C., such as 6° C., 8° C., or even at least 10° C.

The first composition comprises a bleach or a combination of bleaches. This may be a chlorine bleach or an oxygen bleach, but is preferably an oxygen bleach. This may be, for example, hydrogen peroxide or a hydrogen peroxide precursor, an inorganic perhydrate, in particular a percarbonate.

Most preferably the bleach is selected from inorganic peroxy-compounds and organic peracids and the salts derived therefrom.

A preferred percarbonate is sodium percarbonate of the formula 2Na₂CO₃.3H₂O₂. A percarbonate, when present, is preferably used in a coated form to increase its stability. Organic peracids include all organic peracids traditionally used as bleaches, including, for example, perbenzoic acid and peroxycarboxylic acids such as mono or diperoxyphthalic acid, 2-octyldiperoxysuccinic acid, diperoxydodecanedicarboxylic acid, diperoxy-azelaic acid and imidoperoxycarboxylic acid and, optionally, the salts thereof. Especially preferred is phthalimidoperhexanoic acid (PAP).

The bleaching compound may also be a chlorine based bleach compound or precursor such as sodium or calcium hypochlorite. In an embodiment, the first composition further comprises a bleach activator and/or a bleach catalyst.

By “bleach activator”, it is meant herein a compound which reacts with peroxygen bleach, like hydrogen peroxide, to form a peracid. The peracid thus formed constitutes the activated bleach. Suitable bleach activators to be used herein include those belonging to the class of esters, amides, imides, or anhydrides. Examples of suitable compounds of this type are disclosed in British Patent GB 1 586 769 and GB 2 143 231 and a method for their formation into a prilled form is described in European Published Patent Application EP-A-0 062 523. Suitable examples of such compounds to be used herein are tetracetyl ethylene diamine (TAED), sodium 3,5,5 trimethyl hexanoyloxybenzene sulphonate, diperoxy dodecanoic acid as described for instance in U.S. Pat. No. 4,818,425 and nonylamide of peroxyadipic acid as described for instance in U.S. Pat. No. 4,259,201 and n-nonanoyloxybenzenesulphonate (NOBS). The organic peracids such as perbenzoic acid and peroxycarboxylic acids, e.g. PAP, do not require the use of a bleach activator or catalyst as these bleaches are active at relatively low temperatures such as about 30 degrees Celsius and this contributes to such bleach materials being especially preferred according to the present invention.

In an embodiment, the bleach is combined with one or more surfactants. In an embodiment, the combination of a bleach and surfactant is in the form of a concentrated liquid.

The amount of first composition to be added depends upon the capacity of the washing machine and also the volume of laundry to be washed.

The second composition comprises one or more surfactants. The surfactant may comprise a nonionic, anionic, cationic, amphoteric or zwitterionic surface active agents or suitable mixtures thereof may be used. Many such suitable surfactants are described in Kirk Othmer's Encyclopedia of Chemical Technology, 3rd Ed., Vol. 22, pp. 360-379, “Surfactants and Detersive Systems”. In general, bleach-stable surfactants are preferred according to the present invention.

The third composition comprises at least one enzyme selected from: protease, amylase, mannanase, cellulose and lipase. The third composition is substantially bleach-free or, preferably, completely bleach free. In an embodiment, the third composition further comprises at least one surfactant.

The at least one surfactant is advantageously selected from anionic surfactants, which are frequently provided as alkali metal salts, ammonium salts, amine salts, aminoalcohol salts or magnesium salts.

Contemplated as useful are one or more sulfate or sulfonate compounds including: alkyl benzene sulfates, alkyl sulfates, alkyl ether sulfates, alkylamidoether sulfates, alkylaryl polyether sulfates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl phosphates, alkyl ether phosphates, acyl sarconsinates, acyl isethionates, and N-acyl taurates. Generally, the alkyl or acyl radical in these various compounds comprises a carbon chain containing 12 to 20 carbon atoms.

Other surfactants which may be used are fatty acids, amphoteric surfactants, alkyl naphthalene sulfonates and oleoyl sarcosinates and mixtures thereof.

A number of further ingredients can be added to at least one of the first, second and third compositions. For example, builders may be added to any of the compositions used. The builder may be either a phosphate builder or a phosphate-free builder, but is preferably phosphate-free. Preferably it is chosen from amino acid based compounds and/or succinate based compounds. The terms ‘succinate based compound’ and ‘succinic acid based compound’ are used interchangeably herein. Conventional amounts of the amino acid based compound and/or succinate based compound may be used for composition of the present method. Preferred examples of amino acid based compounds which may be used are MGDA (methyl-glycine-diacetic acid, and salts and derivatives thereof) and GLDA (glutamic-N,N-diacetic acid and salts and derivatives thereof).

Preferred examples include tetrasodium imminosuccinate. Iminodisuccinic acid (IDS) and (hydroxy)-iminodisuccinic acid (HIDS) and alkali metal salts or ammonium salts thereof are especially preferred succinate based builder salts.

It is especially preferred according to the present invention that the builder comprises methyl-glycine-diacetic acid, glutamic-N,N-diacetic acid, tetrasodium imminosuccinate, or (hydroxy)-iminodisuccinic acid and salts or derivatives thereof.

Another preferred builder is 2-(I-Carboxy-ethoxy)-2-methyl-malonic acid. Other builders include non-polymeric organic molecules with carboxylic group(s). Builder compounds which are organic molecules containing carboxylic groups include citric acid, fumaric acid, tartaric acid, maleic acid, lactic acid and salts thereof. In particular, the alkali or alkaline earth metal salts of these organic compounds may be used, and especially the sodium salts. An especially preferred phosphorous-free builder is sodium citrate. Such polycarboxylates which comprise two carboxyl groups include, for example, water-soluble salts of, malonic acid, (ethylenedioxy)diacetic acid, maleic acid, diglycolic acid, tartaric acid, tartronic acid and fumaric acid. Such polycarboxylates which contain three carboxyl groups include, for example, water-soluble citrate. Correspondingly, a suitable hydroxycarboxylic acid is, for example, citric acid.

The first composition may further comprise an alkaliser, for example sodium carbonate.

One or more fourth compositions can be added once water has been removed from the wash tank machine after the wash cycle has finished. A fourth composition may comprise of fabric softening agents such as esterquats, silicone paraffin, but also stain protection and removing agents.

The invention is further described with reference to the following non-limiting Examples. Further examples within the scope of the invention will be apparent to the person skilled in the art.

### EXAMPLES

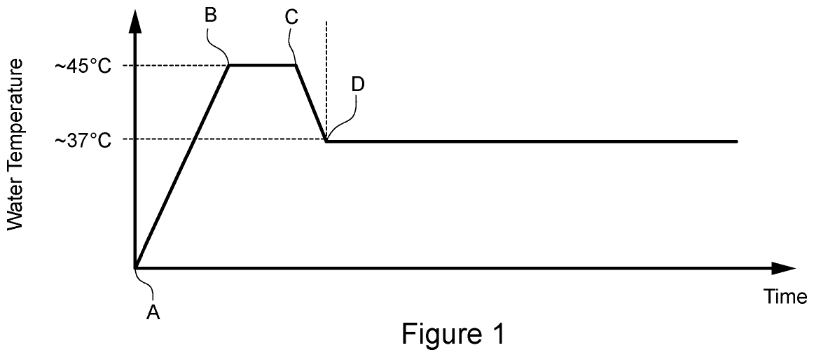

FIG. 1 shows the water temperature profile during a 40° C. cotton wash programme according to an embodiment of the present invention. Initially, the first composition is added at the start of the washing cycle as the water in the tank is heated. This can take place at or between points A and B as shown in FIG. 1. The second composition may be added at the same time as the first composition or after, i.e. between points A and C. The temperature of the wash water is then reduced, as shown in FIG. 1 by line C to D. In the Example shown in FIG. 1, the temperature of the water in the tank is reduced from 45° C. to 37° C. Once the water has been reduced in temperature, the third composition is added. For example, the third composition may be added at point D or after. The temperature of the wash water may be adjusted during the remainder of the wash cycle or maintained at a set temperature.

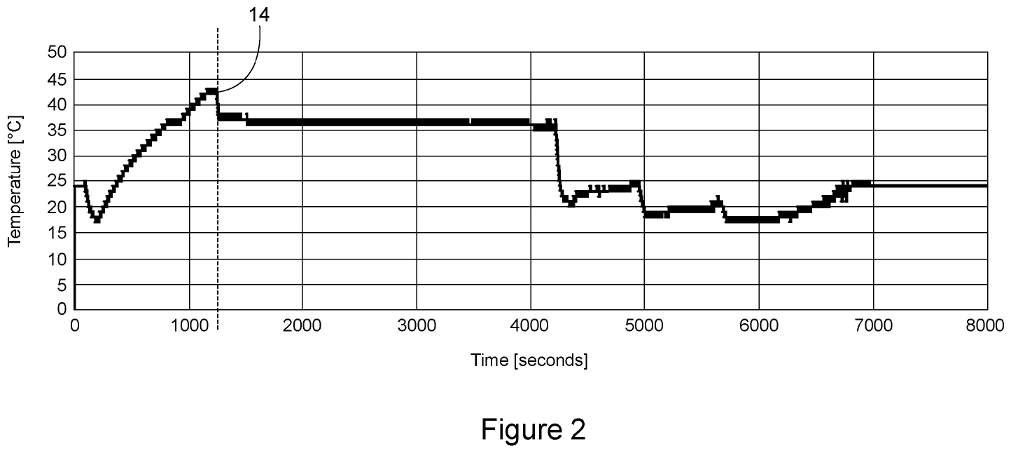

FIG. 2 shows the water temperature profile obtained from a Smeg LSE 147ES automatic laundry washing machine. The step of reducing the water temperature before the addition of the third composition is shown at point ‘14’.

Example 1 demonstrates a method according to the present invention.

Comparative Example 1 demonstrates the of use of the leading brand of automatic laundry detergent in the United Kingdom (Ariel Excel Washing Gel, produced by Proctor and Gamble), together with a commercial stain remover (Vanish Gold powder, produced by Reckitt Benckiser), in a standard washing cycle of a 40° C. cotton wash programme on a Smeg LSE 147ES automatic washing machine.

Comparative Example 2 demonstrates the use of identical quantities of the compositions used in Example 1 added together to the washing machine drum at the start of a standard washing cycle of a 40° C. cotton wash programme on a Smeg LSE 147ES automatic washing machine.

In Example 1 the automatic laundry machine was modified to dose the compositions at predetermined intervals and to reduce the temperature of the wash water by the addition of cool water. Each of the cycles was carried out four times (as identified by A, B, C and D).

Example 1 and Comparative Example 2 both employed:
a first composition comprising 45.00% by weight coated sodium percarbonate, 12.00% by weight TAED, and 0.20% by weight of a bleach catalyst;
a second composition comprising 25.46% by weight non-ionic surfactant and 29.47% by weight anionic surfactant; and
a third composition comprising 32.58% by weight protease, 16.85% by weight mannanase, 39.33% by weight lipase and 11.24% by weight amylase.

Example 1 comprised:
(a) adding 30 g of the first composition was added 0 seconds after the start of the wash cycle;
(b) adding 29.12 g of the second composition added at 0 seconds after the start of the wash cycle; and
(c) introducing half of 0.535 g of the third composition at 0 seconds and the second half was added at 1025 seconds after the start of the wash cycle as soon as the wash water was cooled to 37° C.

Approximately 12 L of water (A 11.78 L, B 11.45 L, C 11.96 L, D 11.45 L) was added during the first step (a). The water in the wash tank was ˜44° C. before approximately 2 L of cool water (A—2.14 L, B—2.13 L, C—2.13 L, D—2.15 L) was added prior to the third step (c). The temperature was thereafter maintained at ˜37° C. prior, during and after the third step (c).

Comparative Examples 1 and 2 were also repeated four times.

The quantity of water used in the drum and the energy consumption for each of the Examples are provided in Table 1 below.

TABLE 1

| | Total amount of water | | | | Average amount | Average energy consumption | |
|---|---|---|---|---|---|---|---|
| | measured in drum [L] | | | | of water | Heating | Total |
| Machine Cycle | A | B | C | D | measure [L] | element (KWh) | cycle (KWh) |
| Example 1 | 62.64 | 60.28 | 60.03 | 58.81 | 60.44 | 0.524 | 0.746 |
| Comparative | 61.42 | 59.94 | 59.94 | 59.26 | 60.14 | 0.636 | 0.826 |
| Example 1 [40° C. | | | | | | | |
| cycle and standard | | | | | | | |
| laundry detergents] | | | | | | | |
| Comparative | 61.48 | 60.9 | 60.42 | 58.81 | 60.14 | 0.636 | 0.826 |
| Example 2 [40° C. | | | | | | | |
| cycle and compositions | | | | | | | |
| used in Example 1] | | | | | | | |

It can be seen from Table 1 that Example 1 uses less energy than a standard 40° C. cotton wash cycle. This is beneficial in both reducing cost to the consumer and of significant benefit to the environment. In addition to these benefits, there was an overall increase in the removal of stains, particularly bleachable and greasy stains, when compared to the market leading brands used above.

Table 2 below shows the results of stain removing tests as carried out in the cycles shown in Table 1. The listed stains are purchased from Center for Test Materials B.V. as standard stains and are attached to towels before being placed in the drum of an automatic laundry machine. A new set of stains was used for each of tests performed in Table 1. The values given are for the percentages of the stain removed when measured on a Datacolor 650 Spectrophotometer.

TABLE 2

| | | | Percentage | Percentage |
|---|---|---|---|---|
| | | Percentage | Average from | Average from |
| | | Average from | cycles A to D | cycles A to D |
| | | cycles A to D | of Comparative | of Comparative |
| Stains: | | of Example 1 | Example 1 | Example 2 |
| Enzymatic | Salad Dressing | 76.6 | 77.3 | 75.7 |
| | Starch | 80.6 | 76.8 | 80.6 |
| | Chocolate | 55.1 | 53.8 | 54.9 |
| | Chocolate Ice Cream | 75.3 | 76.7 | 78.1 |
| | Cocoa | 61.5 | 58.8 | 60.7 |
| | Chocolate Pudding | 75.1 | 76.9 | 73.1 |
| | Sheep Blood | 85.9 | 88.7 | 87.1 |
| AVERAGE | | 72.87 | 72.71 | 72.89 |
| Bleach | Coffee | 85.1 | 84.1 | 84.7 |
| | Red Wine | 81.1 | 76.4 | 80.1 |
| | Carrot Baby Food | 88.5 | 84.8 | 84.1 |
| | Blackberry Unaged | 81.6 | 82.7 | 82.3 |
| | Blackcurrant Juice | 82.3 | 78.5 | 82.5 |
| | Fruit Juice | 74.1 | 74.1 | 73.8 |
| | Grass | 79.3 | 75.6 | 80.0 |
| | Coffee Equest | 83.8 | 83.0 | 84.8 |
| | French Squeezy | 81.0 | 83.2 | 80.7 |
| | Mustard | | | |
| | Grass/Mud | 55.5 | 54.1 | 53.1 |
| | Coffee Express | 71.5 | 71.7 | 69.6 |
| | Red Wine | 81.0 | 74.1 | 79.6 |
| | Tea | 80.1 | 78.1 | 79.0 |
| | Tomato Puree | 84.2 | 80.7 | 79.9 |
| AVERAGE | | 79.2 | 77.2 | 78.2 |
| Greasy | Skin Grease/Pigment | 62.4 | 59.2 | 59.8 |
| | Make Up | 74.2 | 72.7 | 73.3 |
| | Unused Motor Oil | 36.4 | 31.4 | 37.7 |
| | Spaghetti Sauce | 72.5 | 63.7 | 67.3 |
| | Make Up | 78.8 | 73.5 | 76.6 |

| | | | |
|---|---|---|---|
| AVERAGE | 64.9 | 60.1 | 62.9 |

It is well known to use a stain remover in addition to a laundry detergent to remove stains. However, as shown in Table 2, the present invention effectively removes stains without the addition of a stain remover and outperforms the combination of laundry detergent and stain remover.

In particular, Comparative Example 2 demonstrates that it is the cooling step prior to adding the third, enzyme-containing, composition that is responsible for the increase in stain removal and decrease in energy consumption.

The invention is defined by the following claims.

1. A method of washing in an automatic laundry machine having a wash tank, comprising:
delivering a first composition comprising a bleach to the wash tank of the automatic laundry machine in a first step;
delivering a second composition comprising a surfactant to the wash tank of the automatic laundry machine in a second step;
delivering a third composition comprising an enzyme to the wash tank of the automatic laundry machine in a third step,
wherein water is added to the wash tank of the automatic laundry machine at the same time or after the first step but prior to the third step,
wherein the temperature of the contents in the wash tank of the automatic laundry machine is elevated before the third step;
and wherein the temperature of the contents in the wash tank of the automatic laundry machine is subsequently reduced before the third step.

2. The method according to claim 17, wherein the temperature of the contents in the wash tank of the automatic laundry machine is reduced by adding water to the wash tank that has at a temperature lower than that of the water in the wash tank of the automatic laundry machine.

3. The method according to claim 17, wherein the third composition further comprises one or more surfactants.

4. The method according to claim 3, wherein at least one enzyme is dispersed in a solution of the one or more surfactants.

5. The method according to claim 17, wherein the first step further comprises delivering a quantity of the third composition.

6. The method according to claim 5, wherein the quantity of third composition added in the first step is less than or equal to the amount of third composition delivered in the third step.

7. The method according to claim 17, wherein the bleach is an oxygen bleach.

8. The method according to claim 17, wherein the first composition further comprises one or more ingredients selected from the group consisting of a bleach activator a bleach catalyst a builder and an alkalizer.

9. The method according to claim 17, wherein the third composition is substantially bleach free.

10. The method according to claim 17 further comprising:
removing contents from the wash tank of the automatic laundry machine in a fourth sequential step; and
delivering a fourth composition comprising esterquats to the wash tank of the automatic laundry machine in a fifth sequential step.

11. The method according to claim 17, wherein each step has a maximum temperature,
wherein the maximum temperature reached during the first step is between at least 15° C. and no more than 70° C.

12. The method according to claim 17, wherein the contents in the wash tank of the automatic laundry machine is cooled before the third composition is added to the wash to a maximum temperature of no more than 40° C.,
and a maximum temperature reached during one or both of the first and second steps is at least 15° C.

13. The method according to claim 17, wherein the length of time between the first step and third step is no more than 60 minutes,
and the length of the second step is no more than 60 minutes.

14. The method according to claim 17, wherein the volume of wash water used in each step is no more than 20 litres.

15. An automatic laundry washing machine configured to carry out a method according to claim 1.

16. The method according to claim 1, wherein the first composition comprises a bleach composition;
wherein the second composition comprises a surfactant composition;
wherein water is added to the wash tank of the automatic laundry machine at the same time or after the first step; and
wherein the temperature of the contents in the wash tank of the automatic laundry machine is elevated at one or more of before, during or after the first step and before, during or after second step.

17. A method of washing in an automatic laundry machine having a wash tank, comprising:
in a first step, delivering a first composition comprising a bleach composition to the wash tank of the automatic laundry machine;
in a second step, delivering a second composition comprising at least one surfactant composition to the wash tank of the automatic laundry machine;
in a third step, delivering a third composition comprising at least one enzyme to the wash tank of the automatic laundry machine;
wherein the first, second and third steps are sequential;
wherein water is added to the wash tank of the automatic laundry machine prior to the third step;
wherein the temperature of the water in the wash tank of the automatic laundry machine is elevated at one or more of before, during or after the first step and before, during or after second step; and
wherein the temperature of the water in the wash tank of the automatic laundry machine is subsequently reduced before the third step.

18. The method according to claim 7, wherein the inorganic bleach is selected from the group consisting of an inorganic perhydrate and a percarbonate.

19. The method according to claim 17, wherein the third composition further comprises a builder.

20. The method according to claim 11, wherein the maximum temperature reached during the second step is at least 15° C.
